(19) United States
(12) Patent Application Publication
(10) Pub. No.: US 2015/0378320 A1
(43) Pub. Date: Dec. 31, 2015

(54) ELECTRONIC TIMEPIECE HAVING ELECTRONIC WATCH DIAL DISPLAY WITH COUNTDOWN TO SCHEDULED EVENT

(71) Applicant: Google Technology Holdings LLC, Mountain View, CA (US)

(72) Inventors: Megan Knight, Mountain View, CA (US); Ricky J. Hoobler, Lake Bluff, IL (US); Daniel T. Jacobs, San Francisco, CA (US)

(21) Appl. No.: 14/314,682

(22) Filed: Jun. 25, 2014

(51) Int. Cl. G04G 15/00

(52) U.S. Cl. CPC G04G 15/00

(57) ABSTRACT

An electronic timepiece (102) includes an electronic watch dial display (106) having a chapter ring (108) with a plurality of circumferentially-disposed hour positions including a zero hour position (103). The electronic timepiece further includes an event management component (736) that stores event information (120, 122) identifying a start time of a scheduled event (180) and a dial display controller (714) coupled to the electronic watch dial display and the event management component. The dial display controller controls the electronic watch dial display to activate display of a countdown timer feature (130) in response to a current time being within a threshold duration (148) of the start time. The countdown timer feature extends counter-clockwise on the watch dial display from a point aligned with the zero hour position and has a length based on a number of minutes remaining until the start time.

### FIELD OF THE DISCLOSURE

The present disclosure relates generally to electronic timepieces and, more particularly, to user notifications via electronic timepieces.

### BACKGROUND

Cellular phones, personal digital assistants, and other handheld electronic devices often provide calendaring functionality whereby a user is able to manage appointments via the handheld user device. Moreover, these devices also typically notify the user of an impending appointment by providing an audible, vibrational, or visual alert at some fixed duration prior to the appointment. However, the handheld device may not be in proximity to the user, and thus the alert goes unheeded. If the user does have the handheld device nearby, it often is in a pocket, bag, briefcase, or purse, and thus the triggering of the alert often requires the user to go through the effort of locating the device and then accessing the home screen of the device to determine what caused the alert. However, after ascertaining the source of the alert, the user often returns the device back to where it came and the user then may lose track of the time remaining before the appointment. The hassle of interacting with the electronic device in this way often results in the user ignoring the appointment alerts issued by the handheld devices, thereby negating the purpose of the alert and putting the user at risk of running late to an appointment or missing the appointment entirely.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a system having an electronic timepiece with a countdown timer feature and a coordinating electronic device in accordance with at least one embodiment of the present disclosure.

FIG. 2 is a diagram illustrating a behavior of an electronic watch dial display of the electronic timepiece of FIG. 1 with respect to a countdown timer feature and an event scheduling feature displayed at the electronic watch dial display accordance with at least one embodiment of the present disclosure.

FIG. 3 is a diagram illustrating an example implementation of a countdown timer feature at an electronic watch dial display of an electronic timepiece in accordance with at least one embodiment of the present disclosure.

FIG. 4 is a diagram illustrating yet another example implementation of a countdown timer feature at an electronic watch dial display of an electronic timepiece in accordance with at least one embodiment of the present disclosure.

FIG. 5 is a diagram illustrating an example implementation of a countdown timer feature and an event scheduling feature at a rectangular watch dial display of an electronic timepiece in accordance with at least one embodiment of the present disclosure.

FIG. 6 is a diagram illustrating behavior of an electronic watch dial display having a digital clock display and a countdown timer feature in accordance with at least one embodiment of the present disclosure.

FIG. 7 is a block diagram of an example hardware implementation of an electronic timepiece in accordance with at least one embodiment of the present disclosure.

FIG. 8 is a flow diagram illustrating an example operation of an electronic timepiece for controlling an electronic watch dial display so as to display a countdown timer feature and event scheduling feature in accordance with at least one embodiment of the present disclosure.

### DETAILED DESCRIPTION

The following description is intended to convey a thorough understanding of the present disclosure by providing a number of specific embodiments and details involving an electronic timepiece having a watch dial display that displays a countdown timer feature for an upcoming scheduled event. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the invention for its intended purposes and benefits in any number of alternative embodiments, depending upon specific design and other needs.

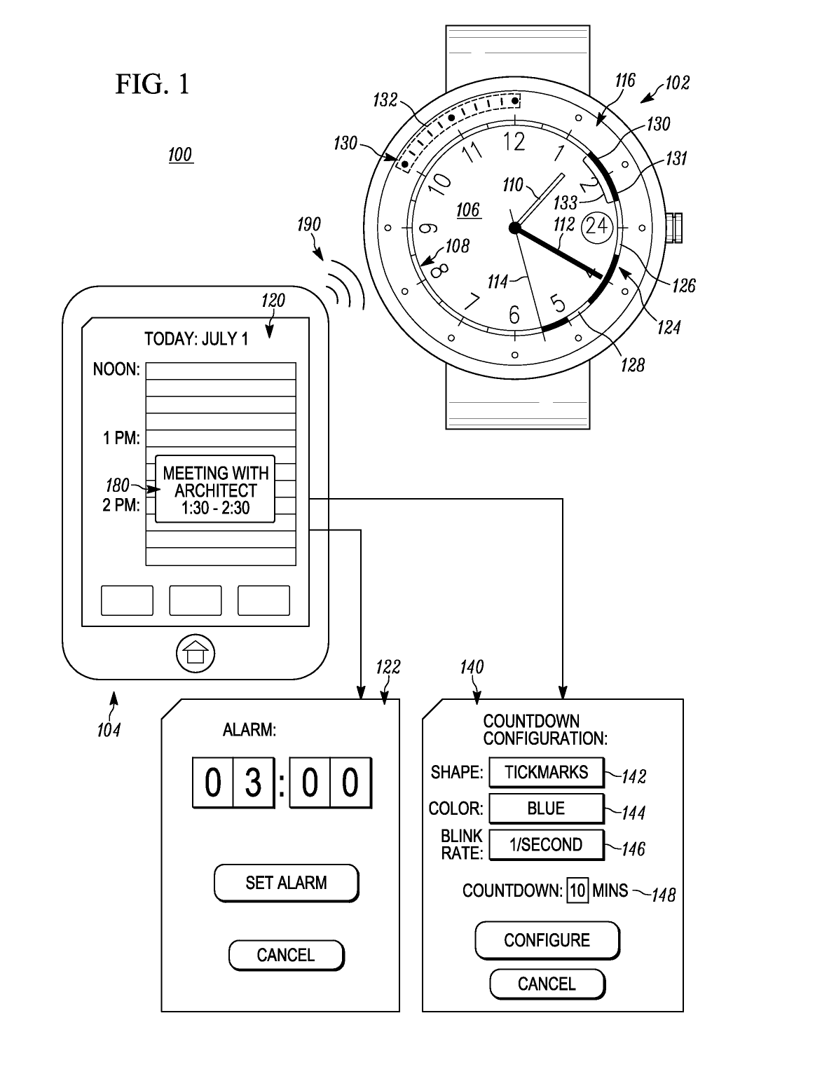

FIGS. 1-8 illustrate example implementations of an electronic timepiece having an electronic watch dial display that displays a countdown to an upcoming scheduled event in a manner that is commensurate with the shape or other design format of the electronic watch dial display. The electronic watch dial display includes a chapter ring congruent with a perimeter of the electronic watch dial display, as well as a countdown timer feature that extends in an arc counter-clockwise from the zero hour position (that is, the “12 o'clock” position for a 12-hour chapter ring or the “24 hour” position for a 24-hour chapter ring). The curve of the countdown timer feature may be congruent or compatible with one or both of the curve of the chapter ring or the curve of the perimeter of the electronic watch dial display. The electronic timepiece receives event information identifying one or more scheduled events. A scheduled event may include a calendar event, such as an appointment or meeting scheduled in a calendaring application, or an alarm event, such as an alarm set to trigger at a specific time, an alarm set to trigger after a specific duration has lapsed, and the like. Other types of scheduled events may include location-specific sunrise, sunset, moonrise, or moonset events or notifications. In response to determining that the current time is within a specified threshold duration of an upcoming scheduled event, the electronic timepiece controls the electronic watch dial display so as to activate the display of the countdown timer feature. As time passes and the start time of the scheduled event approaches, the electronic timepiece controls the electronic watch dial display so as to shorten the length of the displayed countdown timer feature. The length of the displayed countdown timer feature thus remains proportional to the number of minutes remaining before the start time of the scheduled event. In this manner, a user may efficiently assess the time remaining to the next scheduled event by glancing at the electronic watch dial display of the electronic timepiece.

Because of its particular utility in electronic timepieces having wristwatch form factors (that is, “smartwatches”), examples of the electronic timepiece are described in the context of a wristwatch, or smartwatch, implementation. However, the disclosed techniques are not limited to wristwatch form factors, but instead may comprise any of a variety of electronic devices with any of a variety of form factors, such as a computing-enabled cellular phone, a tablet computer, a notebook computer, a digital television, a gaming console, and the like. Further, as analog wrist watches and other analog time clocks traditionally have had circular watch dials commensurate with the rotational sweep of the clock hands, embodiments of the electronic watch dial display of the electronic timepiece primarily are illustrated and described as circular displays. However, using the guidelines provided herein, the electronic watch dial display may instead implement a non-circular shape, such as a rectangular watch dial shape, triangular watch dial shape, a rhomboidal watch dial shape, and the like.

FIG. 1 illustrates an example system 100 utilizing an electronic timepiece 102 and a coordinating electronic device 104 in accordance with at least one embodiment. In the depicted example, the electronic timepiece 102 includes an electronic watch dial display 106 having a chapter ring 108 swept by one or more clock hands, such as an hour hand 110, a minute hand 112, and a second hand 114, as typically is found on analog clock faces. The chapter ring 108 has a ring shape commensurate with the circular perimeter of the watch dial display 106. The chapter ring 108 includes a plurality of hour positions corresponding to the hours in the time span represented by the chapter ring 108. Some or all of the hour positions may be identified by corresponding hour marks, such as the tick-mark and hour number combination shown in FIG. 1. The chapter ring 108 further may include a minute track 116 that includes tick marks or other shapes for the minute positions along the sweep of the electronic watch dial display 106 (hereinafter, referred to as the “watch dial display 106” for purposes of brevity).

In operation, the electronic timepiece 102 receives event information identifying one or more scheduled events pertaining to a user of the electronic timepiece 102 and utilizes this event information to control various aspects of the watch dial display 106. These scheduled events can include calendar events, such as meetings, appointments, and the like, or alarm events, such as alarms set to trigger at a specific time (e.g., 6:15 AM) or alarms set to trigger after a certain amount of time has lapsed (e.g., in 60 minutes). In some embodiments, the event information is received from the coordinating electronic device 104, which may include, for example, a cellular phone, a tablet computer, a notebook computer, a personal digital assistant, a desktop computer, a server, a gaming console, a set-top box, and the like. To illustrate, the coordinating electronic device 104 may provide a calendaring application having a graphical user interface (GUI) to facilitate a user's entry of calendar information 118 (one example of event information) representing various scheduled calendar events into a calendaring database maintained on behalf of the user. As another example, the coordinating electronic device 104 may provide an alarm application having a GUI to facilitate a user's configuration of alarm information 122 (another example of event information) representing one or more alarm events. The coordinating electronic device 104 may communicate 190 with the electronic timepiece 102 to synchronize event data for a specified time range through a wireless link, such as a personal area network (PAN) link or local area network (LAN) link, through a wired link, such through a Universal Serial Bus (USB) connection, and the like. In other embodiments, the user may input event information for one or more scheduled events directly to the electronic timepiece 102, such as through the use of a touch panel or buttons of the electronic timepiece 102, through voice commands received via a microphone of the electronic timepiece 102, and the like.

To notify or otherwise inform a user of scheduled events, in some embodiments the watch dial display 106 employs an event scheduling feature 124 that visually presents the timing of the scheduled events that are scheduled to occur within the time span currently represented by the chapter ring 108. In the depicted example, the event scheduling feature 124 is provided as a schedule ring 126 circling the axis of the clock hands 110, 112, and 114 that augments the chapter ring 108 between the hour number indicators and the perimeter of the watch dial display 106. The schedule ring 126 is divided into a plurality of schedule segments (e.g., schedule segment 128), with each schedule segment representing a corresponding time span (30 minutes in the illustrated example) based on its position relative to the hour positions of the chapter ring 108. For each scheduled event, the electronic timepiece 102 can control the watch dial display 106 so as to alter the appearance of the one or more schedule segments corresponding to the time span of the scheduled event, and thus present to the user an event span indicator that visually represents the start and end times of the corresponding scheduled event (or approximations thereof) relative to the hour indicators of the chapter ring 108, as well as the approximate span of the scheduled event. The one or more schedule segments corresponding to a scheduled event may have their appearance altered by changing their color, their luminosity, by changing them from a constant light projection (i.e., unblinking) to an intermittent, or blinking, light projection, by changing a blink interval or blink pattern, and the like. Moreover, as described below, the appearance of the schedule segments 128 of an event span indicator 133 corresponding to a scheduled event may depend on whether the scheduled event is upcoming or is in progress.

The example of FIG. 1 shows an appearance of the watch dial display 106 with scheduled events occurring from 1:30 to 2:30, 3:30 to 4:30, and 5:00 to 5:30. For the scheduled event starting at 1:30 and ending at 2:30, the watch dial display 106 alters the appearance schedule segments 130 and 131 (corresponding to the 1:30-2:00 and 2:00-2:30 time spans, respectively), such as by changing their coloration from white to grey, so as to collectively provide an event span indicator 133 that graphically indicates that there is a scheduled event occurring from 1:30 to 2:30. The schedule segments 128 of the schedule ring 126 corresponding to the time spans between 3:30 and 4:30 and 5:00 and 5:30 likewise have their appearance altered so as to provide event span indicators for the corresponding scheduled events at 3:30 to 4:30 and 5:00 to 5:30.

The ability to visually ascertain the timing of scheduled events allows the user to anticipate events throughout the day. However, it often is the case that the user also would benefit from knowing the time remaining until the start of an impending scheduled event. To that end, in at least one embodiment the watch dial display 106 provides a countdown timer feature 130 that visually presents both a notification of an impending scheduled event, as well as a visual representation of the time remaining until the start time of the scheduled event. In one embodiment, the countdown timer feature 130 is implemented as a curved indicator 132 originating at a point aligned with the zero-hour position (that is, the 12 o'clock position for a 12-hour dial or the 24^{th} hour position for a 24-hour dial) and extending in an arc or other curve to a point aligned with a position on the chapter ring 108 corresponding to a number of minutes remaining until the start time of the impending scheduled event. The shape or curve of this arc is commensurate with one or more of a curve formed by the hour marks of the chapter ring 108, a curve formed by the minute track 116, a curve formed by a perimeter of the watch dial display 106, or another graphical element of the watch dial display 106.

In one embodiment, the length of the curved indicator 132 is proportional to, or otherwise based on, the time remaining before the start of the scheduled event, and the electronic timepiece 102 controls the display of the curved indicator 132 accordingly. The use of the length of the curved indicator 132 to represent time remaining enables a user to assess how long the user has until the scheduled event with a glance at the watch dial display 106. However, due to space limitations or other design considerations, the extent of the curved indicator 132 on the watch dial display 106 typically is limited to only a portion of the sweep of the watch dial display 106. Thus, the electronic timepiece 102 may trigger the display of the curved indicator 132 only when the time remaining until the next scheduled event is less than a threshold duration representing the maximum time covered by the fullest extent of the curved indicator 132. To illustrate, in the particular example depicted in FIG. 1, the curved indicator 132 incorporates a section of the minute marks of the minute track 116 that, at its fullest extent, extends counter-clockwise from the 0 minute mark to the 50 minute mark. Each minute mark in this section corresponds to one minute in the time remaining until the start time of the next scheduled event. Accordingly, the curved indicator 132 in this example represents a ten minute maximum countdown timer. Thus, the electronic timepiece 102 will not activate the display of the curved indicator 132 until the current time is within the threshold duration of ten minutes of the start time of the next scheduled event.

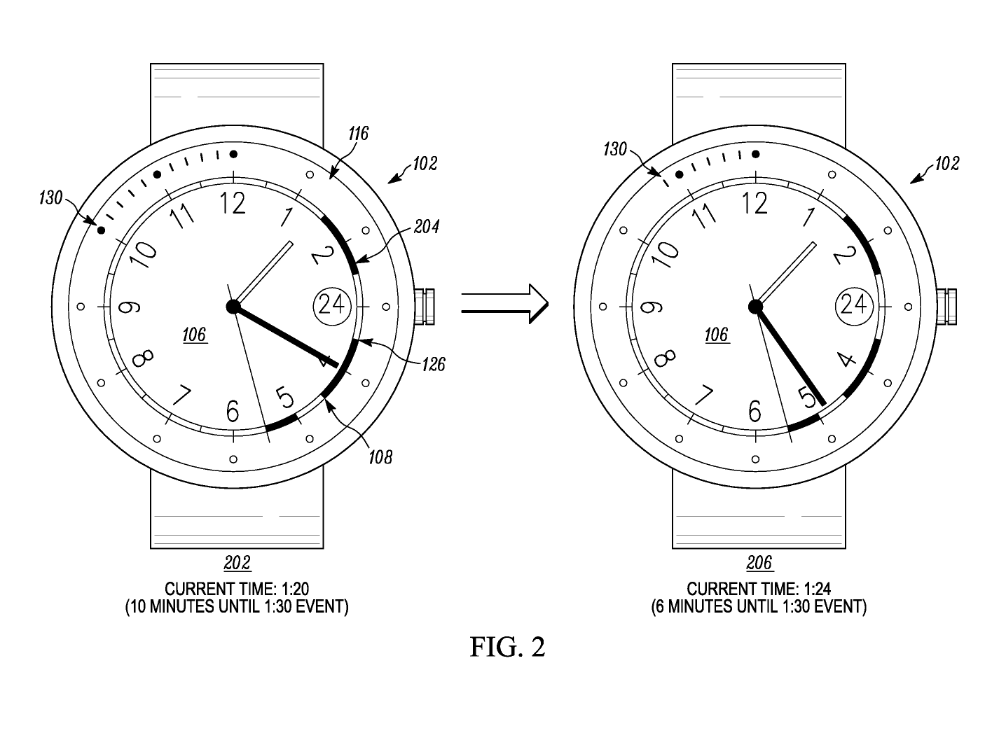

Further, as illustrated in greater detail below with reference to FIG. 2, after activating the display of the curved indicator 132 as triggered by the current time falling within the threshold of the start of the next scheduled event, the electronic timepiece 102 repeatedly shortens the length of the displayed curved indicator 132 with each passing minute until the current time equals the start time of the next scheduled event. When the current time reaches the start time—that is, when the scheduled event has started, the electronic timepiece 102 deactivates the display of the curved indicator 132, and changes one or more appearance attributes of the event span indicator corresponding to the scheduled event so as to indicate that the status of the scheduled event has changed from “upcoming” to “in progress.” The appearance attributes changed in this manner can include, for example, a color attribute, a luminosity attribute, a blink rate attribute, a blink pattern attribute, and the like.

The electronic timepiece 102 utilizes various appearance attributes of display features of the watch dial display 106 to convey information to the user, and in some embodiments the user is able to configure one or more of the appearance attributes used by the watch dial display 106. The user may, for example, customize the colors, luminosities, blink rates, or blink patterns used for the event span indicators 133 or the countdown timer feature 130 or the event scheduling feature 124. Further, the electronic timepiece 102 may facilitate the user's configuration of the threshold duration that triggers the activation of the countdown timer feature 130. To this end, the coordinating electronic device 104 may provide a timepiece configuration application that has a GUI to enable a user to provide user configuration information 140 to configure various parameters of the electronic timepiece 102 as default configurations or to configure one or more scheduled events individually. Parameters may include the shape 142 used to demark each minute (or other time segment) in the countdown timer feature 130, the color 144 of the shape, a blink rate or blink pattern 146, a countdown duration 148, and the like. The user configuration information is received by the coordinating electronic device 104 and the provided to the electronic timepiece 102 as configuration data for implementation. In other embodiments, the user may configure these attributes directly through the electronic timepiece 102, such as by using a GUI displayed at the watch dial display 106 or through the use of voice commands received via a microphone of the electronic timepiece 102.

FIG. 2 illustrates a behavior of the watch dial display 106 of the electronic time piece 102 after the countdown timer feature 130 has been activated in accordance with at least one embodiment of the present disclosure. Display state 202 represents the state of the watch dial display 106 at a current time of 1:20 PM in view of a scheduled event spanning from 1:30 PM to 2:30 PM. This scheduled event is depicted by an event span indicator 204 spanning the portion of the schedule ring 126 spanning from 1:30 to 2:30 in the chapter ring 108. As the meeting has not yet started, in display state 202 the event span indicator 204 has an appearance attribute that indicates the scheduled event is upcoming. This may be represented using, for example, a grey coloration to the event span indicator 204.

For this example, the threshold duration for triggering the countdown timer feature 130 is ten minutes. As the current time of 1:20 PM is within this ten minute threshold of the start time of 1:30 PM, display of the countdown timer feature 130 is activated, and in display state 202 the countdown timer feature 130 represents the full ten minutes remaining, and thus is displayed at its fullest extent by altering one or more appearance attributes of the 50^{th} through 0^{th} minute marks, such as by changing the appearance of these minute marks to a yellow coloration from a default black coloration, or by changing these minute marks to being displayed with a blinking pattern rather than their default of constant display. A user looking at the watch dial display 106 in display state 202 at current time 1:20 PM thus would quickly ascertain that the next scheduled event is at 1:30 and that the user has ten minutes left before the scheduled event starts.

Display state 206 represents the state of the watch dial display 106 at a current time of 1:24 PM. At this point, four minutes have passed, and thus only six minutes remain until the start of the schedule event at 1:30 PM. Accordingly, with as each minute passed after activating the countdown timer feature 130, the electronic timepiece 102 has shortened the length of the countdown timer feature 130 by, for example, reconfiguring the appearance attributes of each of the 50^{th}, 51^{st}, 52^{nd}, and 53^{rd} minute marks back to their default appearance, thereby leaving only the 54^{th}-60^{th} minute marks with an altered appearance. A user looking at the watch dial display 106 in display state 206 at current time 1:24 PM thus would quickly ascertain that the next scheduled event is at 1:30 PM and that the user has six minutes left before the scheduled event starts.

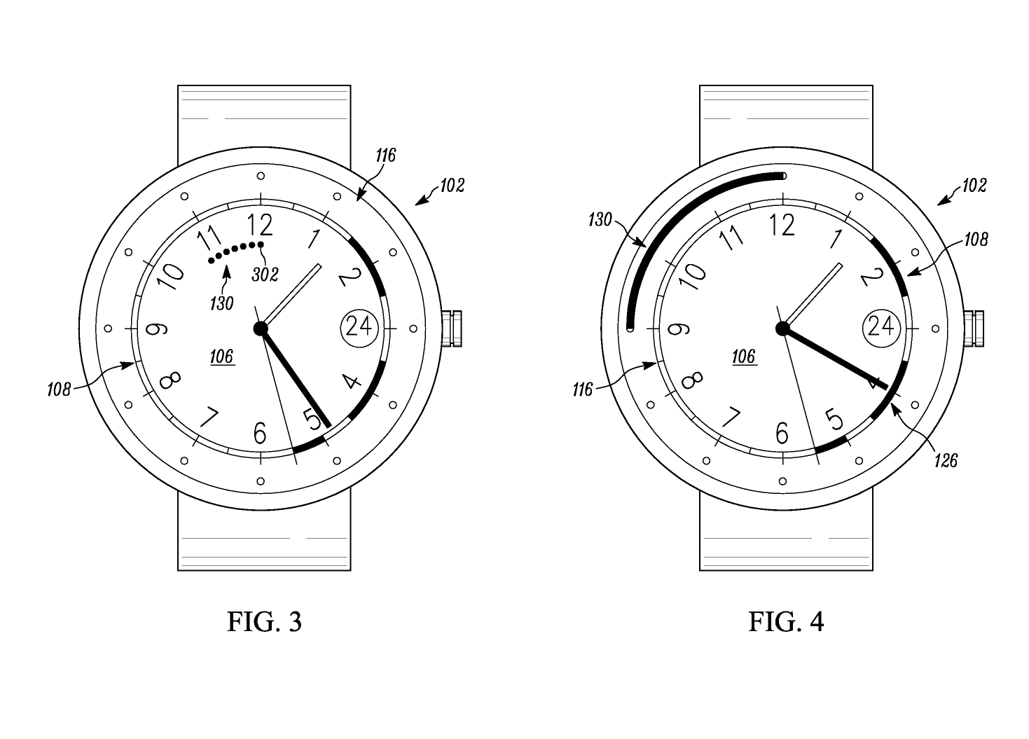

FIGS. 3-5 illustrate additional example implementations of the countdown timer feature 130 of the watch dial display 106 in accordance with at least one embodiment. In the examples above, the configuration of the countdown timer feature 130 includes separate, discrete shapes in the form of minute marks of the minute track 116. These minute marks together form a discontinuous arc that starts at the zero-hour mark and extends counter-clockwise. The length of this arc, and thus the amount of time remaining that the arc length represents, is based on the number of minute marks having the altered appearance attributes attributed to the countdown timer feature 130. However, the countdown timer feature 130 is not limited to this particular example configuration. Rather, as illustrated by the example of FIG. 3, the countdown timer feature 130 instead may be implemented as a set of discrete shapes separate from the minute marks of the minute track 116, such as a set of small dots 302 inside of the hour marks of the chapter ring 108, which are positioned so as to extend in an arc counter-clockwise from the zero-hour position.

Moreover, as illustrated by the example of FIG. 4, the countdown timer feature 130 instead may be implemented as a continuous arc extending from a location aligned with the zero hour position in a counter-clockwise direction and which has a chord length proportional to the number of minutes remaining until the start time of the next scheduled event. In the depicted implementation, the continuous arc forming the countdown timer feature 130 overlies the minute track 116 and represents a maximum time remaining of fifteen minutes, and thus extends in an arc across the sector between the zero hour position and the 9^{th} hour position of the watch dial display 106. In other embodiments, this continuous arc instead may located elsewhere in the sector of the watch dial display 106 corresponding to the maximum number of minutes represented by the countdown timer feature 130, such as overlying the schedule ring 126, overlying the arc described by the hour positions of the chapter ring 108 in that section, between the hour positions and the axis of the clock hands, and the like.

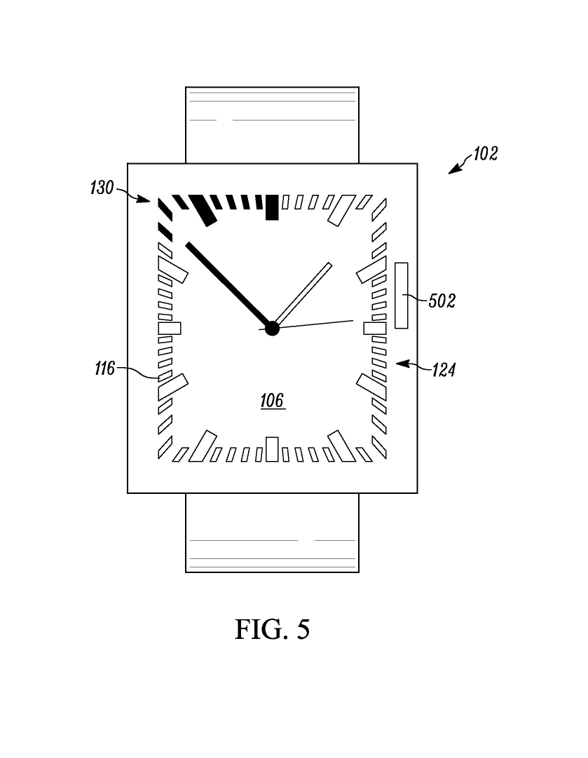

Although FIGS. 1-4 illustrate example implementations of the watch dial display 106 with a circular dial, the electronic timepiece 102 is not limited to circular dial implementations. Rather, the watch dial display 106 may emulate other watch dial shapes. One such example is depicted in FIG. 5, whereby the watch dial display 106 emulates a rectangular watch face shape. In this example, the event scheduling feature 124 may display the timing of scheduled events through the display of event span indicators (such as event span indicator 502) positioned outside the rectangular perimeter formed by the hour marks or the minute track 116 of the watch dial display. Further, the countdown timer feature 130 may be implemented as an arc that follows the sharp curve of the minute track 116 or the perimeter of the rectangular shape of the watch dial display 106 in FIG. 5. As depicted, this may be achieved by incorporating a certain number of minute marks extending counter-clockwise from a point aligned with the zero hour position both as minute indicators for normal time keeping (using one appearance attribute) and as minute indicators for a countdown to the start of the next scheduled event (using a different appearance attribute). Alternatively, the countdown timer feature 130 may be implemented as an arc separate from the minute marks, such as an arc formed on a right-angle path outside of the minute mark path.

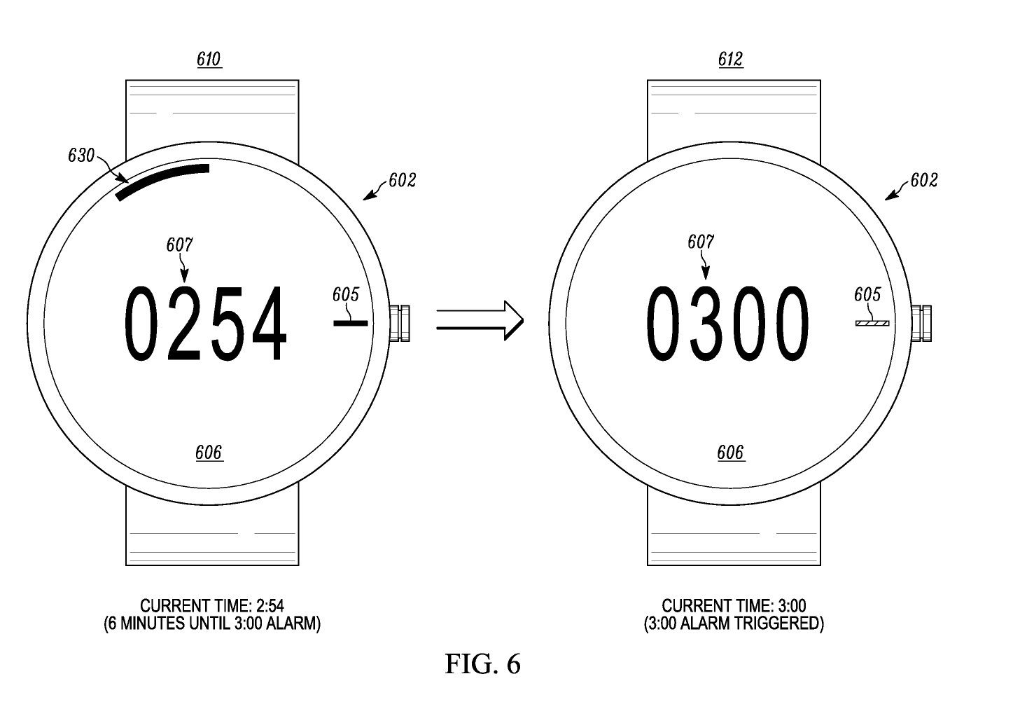

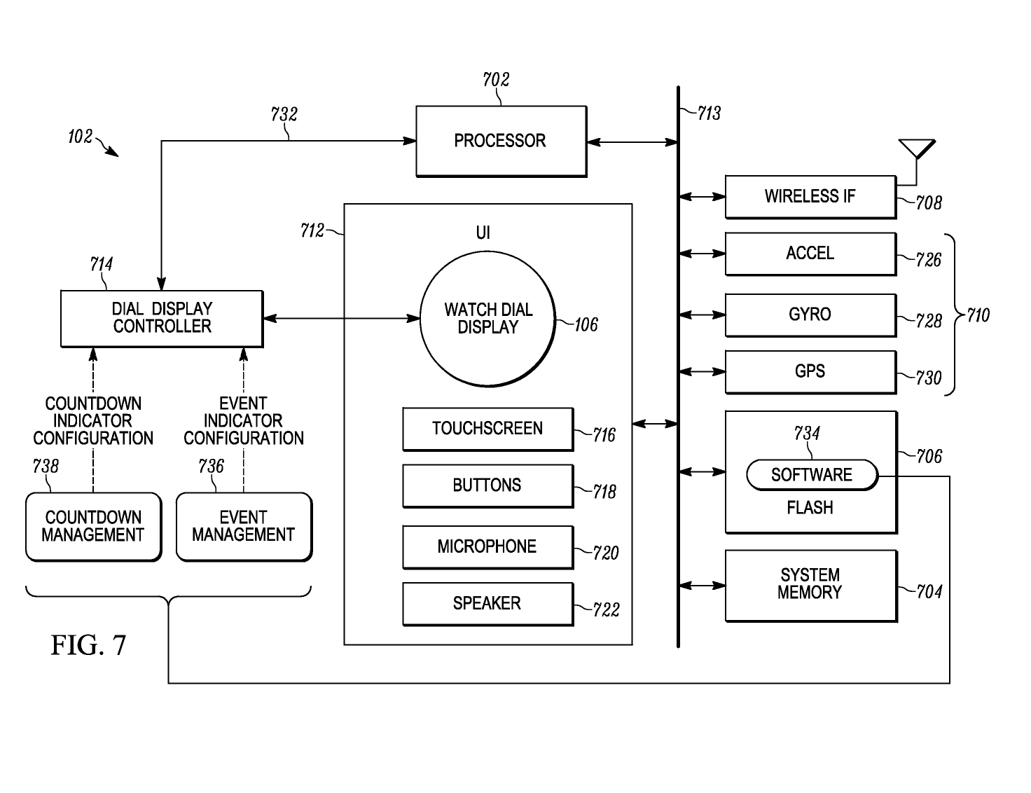

Similarly, although FIGS. 1-5 illustrate example implementations of a watch dial display using an analog watch face configuration with clock hands to indicate the current time, in some embodiments the watch dial display may instead implement a digital time display in combination with implementations of a countdown timer feature and a scheduled event feature. FIG. 6 illustrates an example behavior of an electronic timepiece 602 having a watch dial display 606 with a digital time display 607. The watch dial display 606 includes the digital time display 607 at or near a center of the watch dial display 606. The watch dial display 606 also includes an event scheduling feature whereby event span indicators for corresponding upcoming scheduled events may be displayed along the perimeter of the watch dial display 606 at positions corresponding to the locations of their corresponding start and end times as though the perimeter of the watch dial display 606 represented an analog chapter ring. In the example of FIG. 6, the user has a scheduled event in the form of an alarm event set for 3:00 AM, and thus the watch dial display 606 displays an event span indicator 605 at the 3 o'clock position. As an alarm event typically is set of a single point in time and thus may not have an end time separate from the start time, the event span indicator 605 may treat the alarm event has having an end time at the same time as the start time, or shortly thereafter, and thus represent the alarm event as, for example, a line or thin bar at the 3 o'clock position as illustrated in FIG. 6.

For the following description, the electronic timepiece 602 is assumed to use a fifteen minute threshold for triggering display of a countdown timer feature 630. In the display state 610, the current time is 2:54 AM, or six minutes before the 3:00 AM alarm event, and thus the current time is within the fifteen minute threshold. Accordingly, at the current time the electronic timepiece 602 controls the watch dial display 606 to display the countdown timer feature 630 as an arc extending counter-clockwise from a starting point aligned with the 12 o'clock position and with a length that aligns the end of the arc with what would be the 54^{th} minute mark on an analog chapter ring. Moreover, because the current time has not yet reached the start time of the alarm event, in the display state 610 the event span indicator 605 has an appearance attribute that signifies that the scheduled event that it represents is upcoming. For example, the electronic timepiece 602 may configure the watch dial display 606 to display the event span indicator 605 with a yellow coloration that signifies the corresponding scheduled event as “upcoming” in this example.

At state 612, the current time has advanced to 3:00 AM, which is the start time, or trigger time, for the alarm event. In response to reaching the start time of the alarm event, the electronic timepiece 602 controls the watch dial display 606 to cease display of the countdown timer feature 630 (as the countdown has reached zero), and further to modify one or more appearance attributes of the event span indicator 604 to specify that the corresponding alarm event is no longer “upcoming” but rather “in progress”, such as by changing the coloration of the event span indicator 605 from the yellow coloration to a red coloration, by configuring the event span indicator to blink, or blink faster, or with a different blink pattern, and the like.

FIG. 7 illustrates an example hardware implementation of the electronic timepiece 102 in accordance with at least one embodiment. As illustrated, the electronic timepiece 102 includes one or more processors 702 (e.g., a central processing device or CPU) or other processing component, one or more storage locations, such as system memory 704 and flash memory 706, a wireless interface 708, a set 710 of sensors, and a user interface (UI) 712 connected via one or more busses 713 or other interconnects. The electronic timepiece 102 further includes a dial display controller 714 to control the watch dial display 106 (illustrated as a component of the UI 712). The watch dial display 106 comprises a liquid crystal display (LCD) panel, light emitting diode (LED) display panel, organic LED (OLED) display panel, electronic ink (e-ink) display panel, or other electronic display that is controlled so as to provide an electronic visual display that visually emulates components of a watch or other clock, such as a chapter ring, clock hands, digital numbers, and the like, in addition to providing for the visual display of the countdown timer feature and event scheduling features described herein

The UI 712 receives input from a user, as well as provides information and other signaling to the user, and thus may include, for example, the watch dial display 106, a touch screen 716 or other touch panel (integrated with, for example, the watch dial display 106), one or more hard buttons 718, a microphone 720, a speaker 722, and the like. The set 710 of sensors includes one or more sensors utilized by the electronic timepiece 102 to support its operation. Examples of such sensors can include an accelerometer 726, a gyroscope 728, and a global positioning system (GPS) receiver 730, as well as the microphone 720, the touchscreen 716, and the hard buttons 718 of the UI 712. The dial display controller 714 may be implemented as hard-coded logic, as the processor 702 executing software, or a combination thereof. To illustrate, the dial display controller 714 may be implemented as a field programmable gate array (FPGA) or an application specific integrated circuit (ASIC), such as a graphics processing unit (GPU), that receives signaling 732 from the processor 702 and operates to control the watch dial display 106 accordingly.

In at least one embodiment, the processor 702 operates to execute software 734 stored at one or more non-transitory computer readable media, such as the flash memory 706, the system memory 704, or a hard drive (not shown). The software 734 comprises one or more sets of instructions that, when executed, manipulate the components of the electronic timepiece 102 to provide the functionality described herein. To this end, the software 734 can include an event management component 736 and a countdown management component 738. The event management component 736 operates to receive event information, either from a user's interaction with the UI 712 or from signaling from the coordinating electronic device 104 (FIG. 1). From this event information, the event management component 736 provides various calendaring functions, including the identification of upcoming or in-process scheduled events and configuration of the event scheduling feature 124 via the dial display controller 714 so as to display at the watch dial display 106 one or more event span indicators 133 corresponding to the identified scheduled events 180. The countdown management component 738 operates to receive countdown configuration information 140 indicating a specified threshold duration 148 for triggering display of the countdown timer feature 130 and controls, via the dial display controller 714, the display of the countdown timer feature 130 based on this specified threshold duration, the current time, and the start times of the scheduled events identified by the event management component 736.

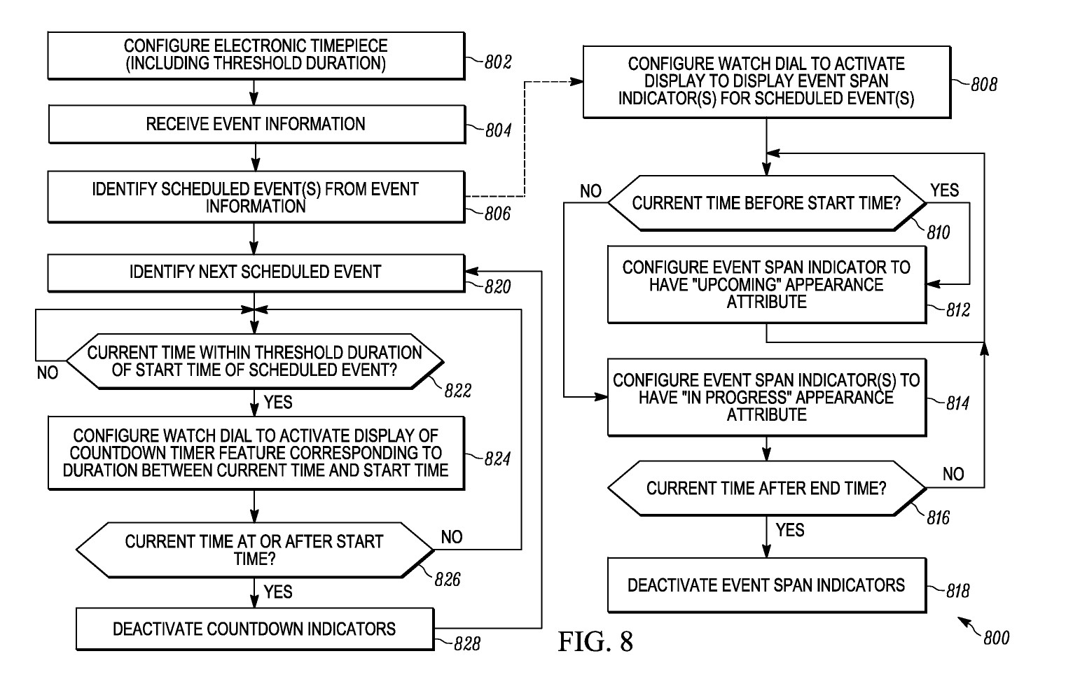

FIG. 8 illustrates a method 800 representing an example operation of the electronic timepiece 102 for display of the countdown timer feature 130 and the event scheduling feature 124 in accordance with at least one embodiment. For ease of illustration, the method 800 is described in the context of the hardware implementation of the electronic timepiece 102 illustrated in FIG. 7.

The method 800 initiates at block 802 with the configuration of the electronic timepiece 102. This configuration includes receiving configuration information 140 regarding the countdown timer feature 130 and the event scheduling feature 124, storing the configuration information at the system memory 704, the flash memory 706 or other storage location, and configuring the electronic timepiece 102 to operate accordingly. This configuration information can include, for example, specification of a value for the threshold duration 148 used to trigger the display of the countdown timer feature 130, specification of one or more appearance attributes 142, 144, 146 (FIG. 1) of the countdown timer feature 130 or the event scheduling feature 124 when activated, and the like. As described above, some or all of this configuration information may be received directly from the user via the UI 712, or received from the user via an application of the coordinating electronic device 104 (FIG. 1).

At block 804, the electronic timepiece 102 receives event information 180 representing one or more scheduled events and stores the event information at a storage location of the electronic timepiece 102. The event information may be received from in the form of calendar information 120 (FIG. 1) describing one or more calendar events from a calendar application of the coordinating electronic device 104, in the form of alarm information 122 (FIG. 1) describing one or more alarm events from a clock application or other application of the coordinating electronic device 104, or a combination thereof. The event information also may be received directly from the user at the electronic timepiece 102 via the UI 712.

At block 806, the event management component 736 analyzes the event information to identify scheduled events that fall within the time span currently represented by the sweep of the watch dial displayed by the watch dial display 106. To illustrate, assuming the watch dial represents a 12-hour clock, and a current time of 2:30 PM, the event management component 736 may analyze the event information to identify all scheduled events occurring between 2:30 PM and 2:30 AM of the next day. At block 808, the event management component 736 configures, via the dial display controller 714, the event scheduling feature 124 of the watch dial display 106 to display an event span indicator 133 for each scheduled event identified at block 806. As described above, each event span indicator is dimensioned and positioned relative to the chapter ring 108 so as to extend across the sector of the watch dial display 106 that corresponds to the time span of the corresponding scheduled event.

For each scheduled event, at block 810 the event management component 736 compares the current time of the electronic timepiece 102 with the start time of the scheduled event to determine whether the scheduled event has started. While the current time is before the start time—that is, the scheduled event has not yet started, at block 812 the event management component 736 configures the corresponding event span indicator to have one or more appearance attributes intended to confer that the corresponding scheduled event is upcoming, and thus may be referred to as an “upcoming appearance attribute.” To illustrate, the event span indicator may be configured to have a muted color, such as grey shading, a muted luminosity, or a constant, unblinking, appearance so as to convey to the viewer that the scheduled event has not yet occurred.

When the current time reaches the start time of the scheduled event, at block 814 the event management component 736 configures the corresponding event span indicator to have one or more appearance attributes intended to confer that the corresponding scheduled event has started and is in progress, and each attribute thus may be referred to as an “in progress appearance attribute.” To illustrate, the event span indicator may be configured to have a bold color, such as yellow or red shading, a bright luminosity, or a blinking appearance so as to convey to the viewer that the scheduled event is in progress.

At block 816, the event management component 736 monitors the current time to determine wither the current time is at or after the end time of the corresponding scheduled event; that is, whether the scheduled event has ended. For an alarm event, the “end time” of the alarm event may be considered to be, for example a specified time after the alarm event is triggered, or when the user interacts with the UI 712 to shut off the alarm event. If the scheduled event has ended, at block 818 the event management component 736 signals the dial display controller 714 to cease the display of the corresponding event span indicator or otherwise deactivates the event span indicator.

As described above, the electronic timepiece 102 can provide visual notification to a user of both an upcoming scheduled event and a time remaining until the start of that scheduled event through the display of the countdown timer feature 130. With the one or more scheduled events identified from the event information, at block 820 the countdown management component 738 identifies the next scheduled event relative to the current time of the electronic timepiece 102. At block 822, the countdown management component 738 monitors the current time relative to the start time of the next scheduled event to determine whether the current time is within the specified threshold duration of the start time. When the current time gets within the threshold duration, the countdown management component 738 activates the display of the countdown timer feature 130 and, in response, at block 824 the countdown management component 738 instructs the dial display controller 714 to display the countdown timer feature with a length proportional to the number of minutes remaining between the current time and the start time of the next scheduled event.

To illustrate, assuming, for example, a threshold duration of ten minutes and a 12-hour dial, when the countdown timer feature 130 is first triggered, it is displayed as a curved visual indicator extending counter-clockwise from a point aligned with the zero-hour position to a point aligned with the 10^{th} hour position. Thereafter, the passing of each minute triggers the countdown management component 738 to shorten the displayed length of the countdown timer feature 130 by a proportional amount (10% in this example). Thus, after five minutes have passed and only five minutes remain until the start time, the countdown timer feature is displayed as a curved visual indicator extending counter-clockwise from the point aligned with the zero-hour position to a point aligned with the 11^{th} hour position.

While the countdown timer feature 130 is displayed, at block 826 the countdown management component 738 compares the current time with the start time of the next scheduled event to determine whether the next scheduled event has started. When the current time reaches the start time, at block 828 the countdown management component 738 directs the dial display controller 714 to deactivate or otherwise cease display of the countdown timer feature for the scheduled event, as it is now in progress. The method flow may return to block 820, whereby the process of blocks 820-828 may be repeated for the next scheduled event identified from the event information received at block 804.

Much of the inventive functionality and many of the inventive principles described above are well suited for implementation with or in software programs or instructions and integrated circuits (ICs) such as application specific ICs (ASICs). It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

It will be appreciated that the methods and the user interface device described herein may include one or more conventional processors and unique stored program instructions that control the one or more processors or other processing components, to implement, in conjunction with certain non-processor circuits, some of the functions of the user interface device described herein. The non-processor circuits may include, but are not limited to, wireless transmitter and receiver circuits, signal drivers, clock circuits, power source circuits, sensor circuits, and the like.

In this document, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

The specification and drawings should be considered as examples only, and the scope of the disclosure is accordingly intended to be limited only by the following claims and equivalents thereof. Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. An electronic timepiece comprising:
an electronic watch dial display having a chapter ring with a plurality of circumferentially-disposed hour positions including a zero hour position;
an event management component to store event information identifying a start time of a scheduled event; and
a dial display controller coupled to the electronic watch dial display and the event management component, the dial display controller to activate display of a countdown timer feature at the electronic watch dial display in response to a current time being within a threshold duration of the start time, the countdown timer feature extending counter-clockwise on the watch dial display from a point aligned with the zero hour position and having a length based on a number of minutes remaining until the start time.

2. The electronic timepiece of claim 1, wherein:
the countdown timer feature has an appearance of a single continuous arc having a chord length proportional to the number of minutes remaining until the start time.

3. The electronic timepiece of claim 1, wherein:
the countdown timer feature has an appearance of one or more separate indicators arranged in a discontinuous arc, wherein the number of separate indicators is based on the number of minutes remaining until the start time.

4. The electronic timepiece of claim 1, wherein:
the event information includes calendar information; and
the scheduled event includes a calendar event.

5. The electronic timepiece of claim 4, wherein:
the dial display controller further is to display an event scheduling feature at the electronic watch dial display, the event scheduling feature including a display of an event span indicator that is aligned with a span of the hour positions of the chapter ring that corresponds to a span of the calendar event.

6. The electronic timepiece of claim 1, wherein:
the event information includes alarm information; and
the scheduled event includes an alarm event.

7. The electronic timepiece of claim 6, wherein:
the dial display controller further is to display an event scheduling feature at the electronic watch dial display, the event scheduling feature including a display of an event span indicator that is aligned with a location of the chapter ring that corresponds to start time of the alarm event.

8. The electronic timepiece of claim 1, wherein:
the countdown timer feature has a first appearance attribute when activated and a second appearance attribute when deactivated.

9. The electronic timepiece of claim 8, wherein:
the first appearance attribute includes a first color and the second appearance attribute includes a second color different than the first color.

10. The electronic timepiece of claim 8, wherein:
the first appearance attribute includes a first luminosity and the second appearance attribute includes a second luminosity less than the first luminosity.

11. The electronic timepiece of claim 8, wherein:
the first appearance attribute includes a blinking appearance and the second appearance attribute includes a non-blinking appearance.

12. The electronic timepiece of claim 1, wherein:
the electronic timepiece is to configure at least one appearance attribute of the countdown timer feature responsive to user configuration information.

13. The electronic timepiece of claim 12, wherein the at least one appearance attribute includes at least one of: a color; a luminosity; a blink rate; and a blink pattern.

14. The electronic timepiece of claim 12, further comprising:
a wireless interface to receive the user configuration information from an electronic device.

15. The electronic timepiece of claim 1, further comprising:
a wireless interface to receive the event information from an electronic device.

16. The electronic timepiece of claim 1, wherein:
the electronic watch dial display has an appearance of an analog watch face with at least one of an hour hand and a minute hand radially positioned to represent a current time.

17. The electronic timepiece of claim 1, wherein:
the electronic watch dial display has a digital time display to display numbers representing a current time; and
the chapter ring at least partially encompasses the digital time display.

18. The electronic timepiece of claim 1, wherein:
the electronic timepiece has a wristwatch form factor.

19. In an electronic timepiece, a method comprising:
receiving event information representing a scheduled event;
displaying a current time at an electronic watch dial display of the electronic timepiece; and
responsive to determining a start time of the scheduled event is within a threshold duration of the current time, activating a display of a countdown timer feature at the electronic watch dial display, the countdown timer feature extending counter-clockwise from a point aligned with a zero hour position of the electronic watch dial display and having a length based on a number of minutes remaining until the start time.

20. The method of claim 19, wherein:
activating a display of the countdown timer feature includes changing at least one appearance attribute of the countdown timer feature.

21. The method of claim 20, wherein:
changing at least one appearance attribute comprises changing at least one of: a color; a luminosity; a blink rate; and a blink pattern.

22. The method of claim 19, wherein:
receiving event information includes wirelessly receiving event information from an electronic device.

23. The method of claim 22, further comprising:
wirelessly receiving user configuration information from the electronic device, the user configuration information specifying at least one appearance attribute for the countdown timer feature.

24. The method of claim 19, further comprising:
displaying an event scheduling feature at the electronic watch dial display, the event scheduling feature including an event span indicator that is aligned with a span of the hour positions of a chapter ring of the electronic watch dial display that corresponds to a span of the scheduled event.

25. The method of claim 19, wherein:
the scheduled event includes one of a calendar event and an alarm event.
